(19) United States
(12) Patent Application Publication
(10) Pub. No.: US 2025/0378145 A1
(43) Pub. Date: Dec. 11, 2025

(54) SYSTEM FOR LINKING PHYSICAL PRODUCTS TO BLOCKCHAIN-CONNECTED DIGITAL ENTITIES AND AUTHENTICATION OF THE PHYSICAL PRODUCTS

(71) Applicant: Joshua Vorbrich, Minneapolis, MN (US)

(72) Inventor: Joshua Vorbrich, Minneapolis, MN (US)

(21) Appl. No.: 19/232,299

(22) Filed: Jun. 9, 2025

Related U.S. Application Data
(60) Provisional application No. 63/658,260, filed on Jun. 10, 2024.

(51) Int. Cl. G06F 21/10; G06F 21/44

(52) U.S. Cl. CPC G06F 21/1011; G06F 21/44; G06F 2221/2103

(57) ABSTRACT

A computer implemented method including receiving, by a computing device, an identifier and an authentication code from an RFID tag associated with a physical object, transmitting, by the computing device, the identifier and the authentication code to a blockchain server system, receiving, by the computing device from the blockchain server system, an authentication indication, the authentication indication having been provided by the blockchain server system responsive to the blockchain server system comparing the identifier to a digital ID stored on a blockchain and comparing the encrypted authentication code to an authentication code and encryption key associated with the digital ID at the blockchain to determine that the product is authentic, and providing, by the computing device and responsive to receiving the authentication indication, an authentication message to a user of the computing device, the authentication message including an indication that the physical object is authentic.

### CROSS-REFERENCE TO RELATED APPLICATION

This application claims priority to U.S. Provisional Application No. 63/658,260, filed on Jun. 10, 2024. The disclosure of the prior application is considered part of and is incorporated by reference in the disclosure of this application.

### TECHNICAL FIELD

This document generally relates to product authentication, product tracking, and combatting counterfeiting of a product by associating an RFID tag with the product and verifying the authenticity of the product based on authentication information stored by the RFID tag using blockchain technology, and a method for authentication using rekeying with changing asymmetric key distributed through existing asymmetric keys.

### BACKGROUND

Counterfeiting is the manufacturing or selling of counterfeit or fake versions of genuine products. Counterfeit products, which are often inferior in quality, pose a threat to the consumers of the product because counterfeiters do not adhere to industry safety and quality standards. The presence of counterfeit products in the marketplace has the potential to negatively impact the brand reputation and the goodwill of the company that legitimately produces the product. The impact of counterfeiting is evident, every year, legitimate business that manufacture products experience revenue losses due to counterfeiting. Fashion and luxury goods, such as designer clothing, shoes, handbags, pharmaceuticals, electronics, and cosmetics are just some of the products which are subject to being counterfeited.

Counterfeiting is a multi-trillion dollar endeavor, and every year, billions of dollars are spent on anti-counterfeiting packaging, to protect products, such as fashion and luxury goods, food and beverage products, pharmaceuticals, and cosmetics, from being counterfeited. Current authentication methods may incorporate physical security features into the products to help verify the product's authenticity. Physical security features are tangible elements which are integrated into product packaging or design to authenticate the product and prevent counterfeiting. These features provide visible or tactile cues that help consumers, retailers, and inspectors to verify the authenticity of the product. For example, producers may include a watermark, a hologram, microprinting, embossing, or a special ink/dye into a product. However, such authentication methods, if copied by counterfeiters, can often be indistinguishable from the originals, allowing the most sophisticated counterfeiters to more easily pass off counterfeit products as authentic. Further, they often require trained individuals or specialized systems to investigate.

### SUMMARY

This document generally describes a system for linking physical products to digital entities, which can be connected to a blockchain, and a method for authenticating the physical products using radio frequency identification (RFID) technology (such as, for example, Near Field Communication (NFC)) and/or other short or long range communication techniques. For example, a manufacturer of a product can attach an RFID tag to the product (or a container or package for the product), and can create a digital counterpart for the tagged product on a blockchain, the authenticity of the product can be verified when a RFID reader/scanner is used to scan the RFID tag on the product. The RFID reader/scanner can communicate with a server and the blockchain that hosts the digital counterpart for the tagged product to verify that the data associated with the product on the blockchain matches the data received from the scan of the product. For example, in one implementation, the system uses a process of asymmetric cryptography and digital signatures with changing keys for the verification process to prevent tag duplication. This verification process can thus guarantee that the product is authentic and was not forged or counterfeited.

Existing authentication methods may incorporate physical security features into the products to help verify the product's authenticity. Tangible elements can be integrated into product packaging or design to authenticate the product and prevent counterfeiting. For example, holograms and watermarks can be embedded into a product or product packaging to provide visual authentication. However, these existing authentication methods have limitations. They can be forged, copied, or duplicated due to weaknesses in their cryptographic strategy and interaction protocol. Further, they do not utilize a blockchain to enhance security and prevent copying by counterfeiters. Incorporating authentication protocols that use, for example, blockchain and RFID as part of the authentication technology not only allows for more secure and trustworthy verification and authentication of products for consumers and within a supply chain, but enables secure product tracking throughout the supply chain while providing transparency and traceability. These features strengthen the robustness of the authentication system and makes it more difficult for counterfeiters to operate.

Additionally, use of blockchain based authentication for products can increase consumer confidence that they are purchasing authentic goods. Attaching products to nonfungible tokens (NFTs) on the blockchain can add a digital element to the product, allowing users to collect or view their products, and allowing brands new data collection, customer relationship management, and personalization opportunities.

In some circumstances, the authentication system can also allow for manufacturers to control the authentication process of goods, for example, by controlling proprietary scanning devices or scanning devices are that are specifically associated with the manufacturer.

In one aspect, a physical item can include an integrated RFID tag, the RFID tag being configured to transmit an authentication code to a scanning device, where the authentication code is encrypted using a private key stored at the RFID tag prior to transmitting the authentication code to the scanning device, where the scanning device is configured to send the code to the server to decrypt the encrypted authentication code using a public key associated with the RFID tag, receive, from the scanning device, an alteration to be applied to the authentication code or private key, where the scanning device is configured to receive the alteration from the server in response to the scanning device providing the authentication code to the server, where the server provides the alteration to the scanning device based on the server authenticating the authentication code based on a key or digital signature associated with a digital ID for the RFID tag stored on the blockchain server, and alter the authentication code or private key using the alteration received from the scanning device to generate a new authentication code or private key. In some implementations, rather than the scanning device providing the encrypted authentication code to the server such that the server decrypts the encrypted authentication code, the scanning device can decrypt the encrypted authentication code using the public key associated with the RFID tag.

In some implementations, the scanning device is a first scanning device and the RFID tag is further configured to transmit the new authentication code to a second scanning device, the second scanning device being distinct from the first scanning device. In some implementations, transmitting of the encrypted authentication code to the scanning device by the RFID tag is performed in response to the RFID tag receiving a query from the scanning device.

In some implementations, the scanning device receives the public key from the blockchain in response to providing an identifier for the RFID tag to the blockchain server, wherein the identifier matches the digital ID for the RFID tag stored on the blockchain. In some implementations, in response to receiving an identifier for the RFID tag from the scanner, wherein the identifier matches the digital ID for the RFID tag stored on the blockchain or server, the server may access the tag's corresponding public key and use it to encrypt an authentication challenge for the key, which is then sent to the scanner to send to the tag. In some implementations, receiving in response the properly encrypted correct answer to this authentication challenge is used to authenticate the tag.

In some implementations, the physical item is a bag and the RFID tag is sewn into the bag. In some implementations, the physical item is a garment and the RFID tag is sewn into the garment. In some implementations, the physical item is a wristwatch. In some implementations, the physical item is an article of jewelry. In some implementations, the physical item is an identification document and/or credential. In some implementations, the physical item is a deed or legal document. In some implementations, the physical item is a container containing one or more products or other items and the authentication code is associated with the one or more products contained within the container. In some implementations, the one or more products contained within the container are pharmaceutical products. In some implementations the one or more products contained within the container are identification documents and/or credentials. In some implementations, the one or more products contained within the container are cosmetic products. In some implementations, the one or more products contained within the container are freight or other cargo. In some implementations, the one or more products contained within the container are production materials. In some implementations, the RFID tag includes information on material properties of the production materials. In some implementations, the one or more items contained within the container are gemstones or precious metal.

In another aspect, a computer implemented method includes receiving, by a computing device, an identifier and an authentication code from an RFID tag, where the RFID tag is associated with a physical object, transmitting, by the computing device, the identifier and the authentication code to a blockchain server system, receiving, by the computing device from the blockchain server system, an authentication indication, the authentication indication having been provided by the blockchain server system responsive to the blockchain server system comparing the identifier to a digital ID stored on a blockchain and comparing the authentication code to a digital signature associated with the digital ID at the blockchain to determine that the authentication code matches the digital signature, and providing, by the computing device and responsive to receiving the authentication indication, an authentication message to a user of the computing device, the authentication message including an indication that the physical object is authentic.

In some implementations, the process of communicating the identifier and the authentication code may not be simultaneous, but part of an extended, back-and-forth communication between the server system, scanner and tag.

In some implementations, the scanner reads the identifier from the RFID tag and transmits the RFID tag's identifier to the server system. The server system, verifying that the identifier matches a corresponding digital ID, may use a key corresponding to the tag and digital ID to encrypt an authentication code that is sent to the scanner by the server, and then sent to the tag by the scanner. The tag, decrypting the authentication code using its own key, and then re-encrypting it with either its same key or a different key corresponding to either the tag itself or the server system such as the server system's public key. The tag's response would then be received by the scanner and sent to the server system. If the message received is the correct response to the authentication code sent, then the tag is authenticated, and the server system sends an authentication message to the scanner. In some implementations, the server system generates a new key pair, or alters the existing key pair used to communicate with the tag. In such implementations, the server system encrypts this new key or alteration, which may be encrypted using the tag's previous key, and sends the encrypted new key or alternation to the scanner to provide to the tag. The server system then updates and saves the new key that corresponds to the tag as the official key for the tag. In some implementations, the server system waits until successful confirmation of the key change has been received before communicating that the product has been authenticated and updating the official key.

In some implementations, messages from the tag, scanner, server system and blockchain may be digitally signed or encrypted.

In some implementations, the authentication code is encrypted when received at the computing device from the RFID tag. In some implementations, the computing device transmits the identifier to the blockchain server system prior to transmitting the authentication code to the blockchain server system, after transmitting the identifier to the blockchain server system, receiving, by the computing device, a public key associated with the RFID tag, where the blockchain provides the public key associated with the RFID tag based on the identifier for the RFID tag matching the digital ID stored on the blockchain, and decrypting, by the computing device, the encrypted authentication code using the public key associated with the RFID tag, prior to transmitting the authentication code to the blockchain server system. In some implementations, after decrypting the encrypted authentication code using the public key associated with the RFID tag and prior to transmitting the authentication code to the blockchain server system, the method further includes encrypting, by the computing device, the authentication code using a private key associated with the computing device.

In some implementations, the method further includes transmitting, by the computing device, a computing device ID associated with the computing device and a digital signature associated with the computing device, where the blockchain server system compares the computing device id and digital signature for the computing device to a corresponding digital device ID and digital signature stored at the blockchain to authenticate the computing device. In some implementations, the blockchain server system provides the authentication indication to the computing device responsive to authenticating the computing device. In some implementations, the method further includes receiving, by the computing device from the blockchain server system, an alteration, the alteration having been provided by the blockchain server system responsive to the blockchain server system determining that the authentication code matches the digital signature stored on the blockchain, and transmitting, by the computing device, the alteration to the RFID tag. In some implementations, the RFID tag alters the authentication code using the alteration transmitted by a scanning device to generate a new authentication code. In some implementations, the method includes receiving, by the computing device, a new authentication code from the RFID tag, transmitting, by the computing device, the new authentication code to the blockchain server system, receiving, by the computing device, a second authentication indication, the second authentication indication having been provided by the blockchain server system responsive to the blockchain server system comparing the new authentication code to an altered digital signature associated with the digital ID at the blockchain to determine that the new authentication code matches the altered digital signature, and providing, by the computing device and responsive to receiving the second authentication indication, a second authentication message to the user of the computing device, the second authentication message including an indication that the physical object is authentic.

In some implementations, the physical object is a consumer product and the RFID tag is integrated into the consumer product. In some implementations, the physical object is a bag and the RFID tag is sewn into the bag. In some implementations, the physical object is a garment and the RFID tag is sewn into the garment. In some implementations, the physical object is stored in a container and the RFID tag is physically attached to the container. In some implementations, providing the authentication message includes displaying, on a display of the computing device, the authentication message. In some implementations, providing the authentication message includes providing an audible message, alert, or tone. In some implementations, providing the authentication message includes activating one or more visual indicators. In some implementations, the one or more visual indicators include one or more colored lights.

In another aspect, a scanner receives an ID from an RFID tag attached to a product or container. The scanner forwards the ID for the RFID tag to a server system. The server system verifies that the ID exists and matches or otherwise corresponds to an approved digital ID. The server system retrieves relevant data associated with the product or a product contained within the container from a blockchain. The server system generates a challenge question and answer. The server system encrypts the challenge question with a public-key corresponding to the RFID tag. The server system sends the encrypted challenge question to the scanner. The scanner sends the encrypted challenge question to the RFID tag. The RFID tag decrypts the communication containing the challenge question using a private key for the RFID tag and generates a response to the challenge question. In some implementations, the response to the challenge could simply be a re-encryption (using the RFID tag's private key, the server system's public key, a session key, or another key) of the decrypted challenge. In some implementations, the response to the challenge could be a simple function, such as an arithmetic function, applied to the challenge. In some implementations, the RFID tag generates the response to the challenge by executing a hash on the challenge based on a pre-established secret code and/or the private key for the RFID tag. The RFID tag encrypts the response to the challenge question and transmits the encrypted response to the scanner. The scanner sends the encrypted response to the server system. The server system decrypts the response and compares the decrypted response to the answer to determine if the response is correct. If the response is correct, the server system generates an alteration for a tag-server key pair. The server encrypts the key alteration using the RFID tag's public key and sends the encrypted key alteration to the scanner. The scanner sends the encrypted key alteration to the RFID tag. The RFID tag decrypts the encrypted key alteration using the private key for the RFID tag. The RFID tag uses the key alteration to alter or replace the private key for the RFID tag with a new, updated private key for the RFID tag. The RFID tag stores the updated private key for the RFID tag. The RFID tag sends a confirmation message to the scanner. The scanner sends the confirmation message to the server system. The server system updates the blockchain and product data. This updating can include updating the public key corresponding to the RFID tag to a new public key that can be used in conjunction with the new private key for the RFID tag. For example, the server system can communicate with a key managing server system to update the public key for the RFID tag to the new public key. The server system sends a confirmation message to the scanner. The scanner communicates a message of product authenticity to a user of the scanner.

In some implementations, the server system generates a new public key by running a function on the old public key for the RFID tag. The server system then sends this same function to the RFID tag (via the scanner). The RFID tag then runs this function on the old private key stored at the RFID tag to generate a new private key for the RFID tag. The RFID tag then stores the new private key as the private key for the RFID tag.

In another aspect, a scanner receives an identifier (UID) from an RFID tag associated with a product or a container. The scanner transmits the identifier to a blockchain server system. The scanner receives an authentication challenge code from the blockchain server system. The scanner transmits the authentication challenge code to the RFID tag. The scanner receives an authentication challenge response code from the RFID tag. The scanner transmits the authentication challenge response to the blockchain server system. The scanner receives an authentication indication from the blockchain server system. The scanner provides an authentication message for the product or container to a user of the scanner that confirms or denies the authenticity of the product or container.

In another aspect, a system is provided. The system includes one or more computers and one or more storage devices on which are stored instructions that are operable when executed by the one or more computers, to cause the one or more computers to perform operations including receiving, by the computing device, an identifier and an authentication code from an RFID tag, wherein the RFID tag is associated with a physical object, transmitting, by the computing device, the identifier and the authentication code to a blockchain server system, receiving, by the computing device from the blockchain server system, an authentication indication, the authentication indication having been provided by the blockchain server system responsive to the blockchain server system comparing the identifier to a digital ID stored on a blockchain and comparing the authentication code to a digital signature associated with the digital ID at the blockchain to determine that the authentication code matches the digital signature, and providing, by the computing device and responsive to receiving the authentication indication, an authentication message to a user of the computing device, the authentication message including an indication that the physical object is authentic. The system can perform any of the method steps recited above.

In yet another aspect, a non-transitory computer readable medium is provided. The non-transitory computer readable medium stores instructions that are executable by a processing device, and upon such execution cause the processing device to perform operations. The operations include receiving, by the computing device, an identifier and an authentication code from an RFID tag, where the RFID tag is associated with a physical object, transmitting, by the computing device, the identifier and the authentication code to a blockchain server system, receiving, by the computing device from the blockchain server system, an authentication indication, the authentication indication having been provided by the blockchain server system responsive to the blockchain server system comparing the identifier to a digital ID stored on a blockchain and comparing the authentication code to a digital signature associated with the digital ID at the blockchain to determine that the authentication code matches the digital signature; and providing, by the computing device and responsive to receiving the authentication indication, an authentication message to a user of the computing device, the authentication message including an indication that the physical object is authentic. The instructions stored on the non-transitory computer readable medium can, when executed, cause the processing device to perform any of the method steps recited above.

Other benefits and advantages will be apparent from the following descriptions.

### DESCRIPTION OF DRAWINGS

FIG. 1 is diagram of an example system for authenticating products using RFID and blockchain authentication.

FIGS. 2A and 2B show examples of authentication notifications.

FIG. 3 is a flowchart of an example process for providing an authentication message to a user.

FIG. 4A is a flowchart of an example process for providing an alteration to an RFID tag.

FIGS. 4B-1 to 4B-3 depict a swim lane diagram of an example process for authenticating and providing an alteration to an RFID tag.

FIG. 5 is a schematic diagram that shows an example of a computing system.

Like reference symbols in the various drawings indicate like elements.

### DETAILED DESCRIPTION

The brand reputation and goodwill of a manufacturer of a product is essential to their business. The presence of counterfeit items which forge genuine products produced by these manufacturers therefore pose a risk to the success of the business. Not only does the presence of counterfeit products in the marketplace cause a potential loss of revenue to the manufacturer, but counterfeit products pose a threat to consumers as well. Most counterfeit products are inferior to the authentic product and do not adhere to industry safety and quality standards. Products which are particularly suspect to counterfeiting may include designer goods, luxury clothing, shoes, pharmaceuticals, cosmetics, electronics, food, and fairtrade goods. Incorporating security features in an attempt to mitigate potential forging of a product, in addition to developing authentication methods to authenticate products are import considerations for manufacturers of products. These considerations are constantly evolving as counterfeiters become more sophisticated.

Traditional security and authentication techniques include incorporating physical security features into a product. For example, using holograms and or watermarks which are embedded into a product help provide visual authentication to consumers. However, these traditional techniques do have limitations, especially as counterfeiting methods continue to advance. Due to these limitations, there is a need for more sophisticated product security and authentication methods.

Described herein is an authentication method that integrates physical products to a blockchain infrastructure and uses RFID technology to tag and authenticate products. A newly manufactured product is represented by a unique digital token which is created to represent the product on the blockchain. The unique digital token is a digital representation of an individual product, and acts as a digital certificate of authenticity of the product. The unique digital token is generated to include all of the data and attributes associated with the product. For example, the digital token can include records of ownership and transaction history associated with the product. When the unique digital token is created for the product, a physical unique identifier on the product, for example, an RFID tag, is associated with the product through a tokenization process. For example, an RFID tag associated with a product may be encoded into a digital format and is stored on the blockchain.

A product with an affixed RFID tag can be authenticated using a scanner or RFID reader which communicates with the blockchain server (e.g., through a network such as the Internet) to verify that the product's authentication data matches the data stored on the blockchain or that the authentication data is otherwise correct. For example, the blockchain server can issue a challenge to the RFID tag (provided to the RFID tag via the scanner). The RFID tag can generate a response to the challenge and provide the response to the blockchain server (via the scanner). The blockchain server can then determine if the response to the challenge matches an anticipated response to the challenge to authenticate the RFID tag. Tying the physical products to the blockchain ensures that all of the data associated with the product that is stored on the blockchain is immutable and secure. In addition, the communications between the RFID tag, the reader, and the server system are secured through the use of various different encryption methods. For example, an asymmetric encryption method which requires the use of a private and a public key to encrypt and decrypt communicated data.

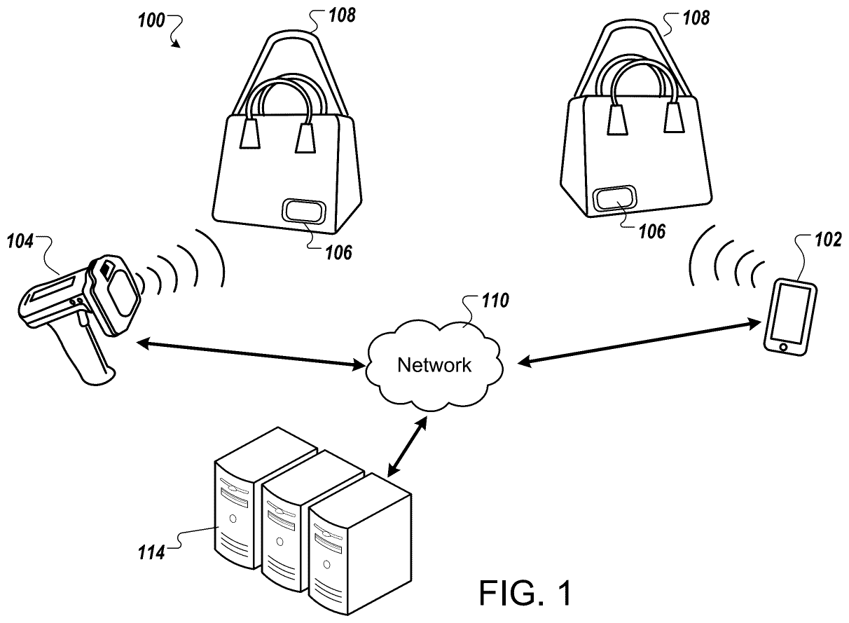

FIG. 1 is diagram of an example system 100 for authenticating products using RFID technology and blockchain authentication. In the system 100, a user, such as a product manufacturer, who wishes to authenticate a product 108 can use RFID reader functionality of a multi-purpose computing device 102 or a dedicated RFID scanner 104 to scan/read an RFID tag 106 located on the product 108. The mobile multi-purpose computing device 102 can be, for example, a mobile phone, a tablet device, a touch screen computer, a laptop computer, a PDA, a smart watch, smart glasses, virtual reality or augmented reality system, or other mobile device. In some implementations, a non-mobile device having the same or similar functionality (such as a desktop computer or server or dedicated scanning device) is used in place of the mobile device 102. In some implementations, the device 102 can have a scanning application installed on the device 102 that allows the device 102 to function as an RFID scanning device. The RFID scanner 104 can be, for example a handheld RFID scanner, a large RFID scanning gate, an RFID sweeper, or any other suitable RFID reader. In some implementations, the RFID tag 106 can be a passive RFID. In some implementations, the RFID tag 106 can use Near Field Communication (NFC) to communicate with the multi-purpose computing device 102 and/or the RFID scanner 104.

In some implementations, the RFID scanner 104 may be a proprietary scanning device that is controlled by a manufacturer of a product 108. For example, the RFID scanner 104 can be proprietary such that the RFID scanner 104 is controlled, licensed, or otherwise gatekept by a specific party (such as a corporation, brand, or individual) to give that party exclusive ability to verify products or other items. In some implementations, the party in control of the scanner can charge a commission for authentication of the product or item, such as a percentage of a resale value for the product or item. For example, a party could charge a commission to a reseller for use of the scanner to authenticate a product or item. Use of a proprietary RFID scanner could also allow a party to ensure that only verified resellers are permitted to resell products. For example, the party could restrict the ability to resell products by providing scanners to only authorized resellers.

In some implementations, tracking of the use of the RFID scanner and authentication system can allow a party to collect data about the product or customers or determine how many times a product or item has been authenticated. By tracking the amount of times that the proprietary RFID scanner is used, a party would be able to track how many times a particular product or item is resold.

The RFID reader on device 102 and the RFID scanner 104 can communicate with a blockchain server 114 through network 110. The network 110 is configured to enable exchange of electronic communications between devices connected to the network 110. The network 110 may include, for example, one or more of the Internet, Wide Area Networks (WANs), satellite connections, Bluetooth, Local Area Networks (LANs), analog or digital wired and wireless telephone networks (e.g., a public switched telephone network (PSTN), Integrated Services Digital Network (ISDN), and a cellular network.

The manufacturer of a product 108 may integrate an RFID tag 106 into the product 108. Alternatively, the RFID tag can be affixed to the product 108, a container or, packaging for the product 108 or otherwise associated with the product 108. In some implementations, the RFID tag 106 is integrated into, affixed to, or otherwise associated with the product (or a container or packaging for the product) at the time of sale or at some other time along a supply chain (such as arrival at a retail store or distribution site, or after passing an inspection or verification). The product 108 can be, for example, a luxury good, an electronic device, a cosmetic product, a pharmaceutical product, designer jewelry, a luxury watch, a piece of art, a shipping container, raw materials, wine, alcohol, documents, identification materials, an item of clothing, or any other suitable physical product. For example, as illustrated in FIG. 1, the product may be a luxury handbag 108. Manufacturers of consumer products may integrate RFID tags into the consumer product as a security measure to prevent counterfeiters from reproducing counterfeits. In some implementations, the RFID tag 106 is sewn into product 108. For example, the RFID tag 106 can be sewn into the product 108 during the manufacturing process and may not be visible to the naked eye. In some implementations, the RFID tag 106 is attached to the packing of a product 108. For example, the RFID tag 106 can be integrated into an adhesive label or a sticker that may be attached to packaging of the product 108. In some implementations, the RFID tag 106 can be small and light weight, for example, an RFID tag 106 which can be used on a jewelry product. In other implementations, the RFID tag 106 can be flexible and/or stretchable in one or more directions. In some implementations, the size of the RFID tag can be selected so as to affect the transmission range of the RFID tag. For example, an RFID tag having a larger antenna can have a greater communication distance than an RFID tag with a comparatively smaller antenna. In some cases, the size of the product 108 may dictate the size of the RFID tag 106 and/or the antenna for the RFID tag 106. In some implementations, in place of or an addition to an RFID tag, another device or devices capable of wireless communication can be integrated into or otherwise associated with the product 108. For example, an NFC (near field communication) tag can be utilized in place of the RFID tag 106. Although this document generally refers to RFID tags, other such devices, such as NFC tags, would operate in a similar manner and are considered to be within the scope of this disclosure. For example, NFC is a type of RFID communication. In some implementations, microprocessors, chips or smart cards such as javacards or microprocessor smart cards, may be used for the RFID tag 106.

In some implementations, an authentication device that relies on wired, infrared, visual (e.g., changing visual signals), audible, or another form of communication may be used in place of or in addition to the RFID tag 106. For example, a device that uses contact-based communication or can physically dock with or otherwise connect to the device 102 to communicate with the device 102 can be used in place of the RFID tag in some implementations.

A digital equivalent for product 108 and/or the RFID tag 106 can be generated or otherwise associated with the product 108 or RFID tag 106. For example, a blockchain server 114 can generate or associate a digital equivalent for the product and/or the RFID tag 106. The digital equivalent of the RFID tag 106 is stored on the blockchain along with other data, such as metadata, authentication logs, and corresponding encryption data such as keys or information required to access secure data, associated with the product 108. For example, a digital identification code for a tag may be stored at the blockchain. In some implementations, a digital identification code and a digital signature are both stored at the blockchain and are specific to a specific RFID tag 106. In some implementations, a digital identification code and an encryption key are both stored at the blockchain and are specific to a specific RFID tag 106. For example, the blockchain server 114 can store a public key for the RFID tag and use the public key to encrypt communications intended for the RFID tag. In some implementations, the public key may be not entirely public, but rather kept secret by the blockchain server 114 (yet still be a distinct key from the private key of the RFID tag that is known only to the RFID tag). In some implementations, a secure storage service such as a secure key management service might be used to store keys or other sensitive data, in which case the secret name, location, or credentials required to access the secure storage corresponding to the digital signature or key associated with the tag may be stored in the blockchain along with its digital identification code.

The physical product 108 can be connected to a blockchain server 114 to enhance anti-counterfeiting security measures for the product 108. In some implementations, the blockchain server 114 can be implemented as a single server, as a networked server, as a plurality of network servers (either collocated or geographically dispersed) or any other computing system capable of communicating through the network 110 and storing relevant information. For example, the blockchain can be stored as part of a “cloud” storage system.

In some cases, the server 114 may operate on the blockchain as a blockchain server. The scanner 104 may connect directly to the blockchain to execute operations and in some of these cases there may not be an off-chain server. In other cases, a server off-chain will serve as an intermediary between the scanner 104 and the blockchain. In some cases the server system 114 may use a public or private blockchain and it may be centralized or decentralized. In some cases the blockchain or server system may be controlled by the company that produced the product 108 or a third party.

In some cases, the blockchain may be used to associate each product with an NFT. This could be used for security reasons, such as to prevent the creation of additional, fake product authentication certificates, or other reasons such as providing digital collectables or allowing entities to track and manage their collections and products. Smart contracts may be used to control the creation and properties of these NFTs and update their information as necessary such as with new key or security information, verification history, audit information or sales updates.

In more details, a manufacturer can create a digital representation for physical product 108 to represent the product 108 on the blockchain. For example, the manufacturer can generate a unique digital token which acts as a digital certificate of the authenticity of the product 108. In some implementations, a number or code such as a unique identifier (UID) may be used as an identifier to represent the product 108, and then this data may be stored on the blockchain. In some implementations, the UID associated with a physical product 108 may correspond to a different digital ID. In some implementations, this UID or digital ID and other product data may be hashed, and the system may only store the hashed versions of this data for added security. In some implementations, the data may be stored off of the blockchain, and the blockchain will be used to store the location of this data (e.g., the blockchain stores links to information associated with the product 108). In some implementations, the unique digital token may be a unique identification number, a unique character string, a product certification, a non-fungible token (NFT), a digital twin, tokenized, or any other suitable digitized representation of the physical product. The RFID tag 106 associated with the product 108 can also be encoded into a digital format and stored on the blockchain along with other data associated with the product 108. In some implementations, the digital format for the RFID tag 106 may be a unique digital ID. In some implementations, the unique digital ID for an RFID tag 106 can be associated with an encryption key that is stored in a secure key manager, the address of which is stored in the blockchain. In some implementations, the unique digital ID for an RFID tag 106 can be associated with a digital signature which can be stored together with the digital ID, or in a separate but corresponding location. The blockchain can provide a decentralized and immutable ledger that stores some or all the data associated with a digital token. For example, the digital token, information for users, certifications, awards, tickets, demerits, regulatory information, compliance information, environment social and governance information, product provenance, the manufacturer, the owner, information about if the product was stolen, the date of creation, the date of sale, or any other relevant data may be stored on the blockchain. The blockchain may store data related to the process of verifying the authenticity of the product, such as the corresponding encryption key, or the location, name, or password needed to access this key from another source. Because the data recorded on the blockchain cannot be altered, the immutable records are secure and verifiable. The blockchain may also provide auditing features to track verifications, sales, supply chain events and prevent counterfeiting and inform responses in the event of an attack.

As illustrated in FIG. 1, a user may scan a product 108 that is tagged with an RFID tag 106 to determine whether the product 108 is authentic or not. In some implementations, the user may be an employee or associate of the manufacturer or seller of the product 108. In other implementations, the user may be an individual that is interested in purchasing the product 108 (e.g., either from a retailer or secondhand from someone who previously purchased the product 108). In some implementations, the user may be the original producer, manufacturer, or seller interested in tracing their inventory or keeping track of product information. In other implementations, the user may be an individual or organization that is interested in purchasing the product 108 (for example, from a retailer or second hand from a person or organization who previously purchased the product 108, a resell organization, the original producer, and an organization with scanning and verification capabilities) or to access information about the product. In some implementations, the user may be a law enforcement officer or a regulatory officer such as an import/export related official. For example, the user may be a customs and boarder control agent that wants to verify the authenticity of one or more products 108, check if they comply with certain regulations, or check if they have already been inspected or approved.

The RFID reader 102 or 104 scans the RFID tag 106 affixed to or otherwise associated with the product 108, and can request specific data from the RFID tag 106. In response to the RFID reader 102 or 104 requesting specific data from the RFID tag 106, the tag 106 transmits the requested data and a digital ID associated with the tag 106 to the reader 104 or 104 which, in turn, provides some or all of the received information to the blockchain server 114 to authenticate the product 108. In other implementations, the tag 106 transmits a digital ID along with an encrypted authentication code to the RFID reader 102 or 104. For example, the RFID tag 106 may encrypt the authentication code using a private encryption key of the RFID tag 106.

In other implementations, the tag 106, the scanner 102 or 104, and the server 114 may have a more complicated multi-stage set of interactions. In some implementations, the scanner 102 or 104 may first read the UID or other identifying information from the tag 106 and then forward this information to the server 114. The server 114 may then check whether this identifying information corresponds with an approved tag and if so, may send back a challenge question (an authentication challenge) to the scanner 102 or 104, encrypted with an encryption key corresponding to the tag 106, which may be stored secretly on the server 114, the blockchain, or separate secure storage. For example, the encryption key may be a pseudo-public key for the RFID tag that is not published or otherwise known to the general public and is kept secret by the server 114 or an affiliated server system, with the pseudo-public key being the corresponding asymmetric pair of the private key for the RFID tag 106, and being distinct (asymmetric) from a private key for the RFID tag 106. The scanner 102 or 104 receives the encrypted challenge and forwards the encrypted challenge to the tag 106. The RFID tag 106 decrypts the challenge and then formulates an answer to the challenge question. The RFID tag 106 then sends the formulated answer back to the scanner 102 or 104. In some cases, the RFID tag 106 encrypts the answer using the same or a different encryption key related either to the tag 106, the scanner 102 or 104, or to the server 114. The sever 114 and blockchain then verify if this answer is correct. If so, the server 114, scanner 102 or 104 or the RFID tag 106 itself may change the key stored on the RFID tag 106. The server 114 may send a confirmation message to the scanner 102 or 104 to communicate that the tag 106 is verified and authentic. The server 114 may wait to send this communication until after the key change on the tag 106 has been confirmed. Upon authentication, the server may generate a new key pair for the tag 106, or an iteration of the tag's old key. For example, the server 114 may generate a new public/private key pair. In some implementations, the public key in the public/private key pair is not made public, but is a pseudo-public key that is kept secret by the server 114. The new key for the RFID tag 106 may be distributed to the RFID tag 106 by encrypting it using the previous public key for the RFID tag 106. The server 114 may also send information that may be stored on the server 114 or the blockchain that is related to the product 108 or to the scanner 102 or 104.

In some implementations, this alteration may take place such that the server never knows the tag's private key. For example, the server generates an update token (alteration code). The server combines this update token with the previous public key or a master public key corresponding to the RFID tag to generate or derive a new public key. The server sends this update token to the RFID tag, which combines this token with a private secret—a private key, scalar, or master seed—in order to compute the matching private key.

In some implementations, this alteration may take place such that the server never knows the tag's private key. For example, the server generates an update token (alteration code). The server uses this update token with the previous public key corresponding to the RFID tag to generate a new public key. The server sends this update token to the RFID tag, using the previous public key to encrypt the message. The RFID tag applies this update token to their existing private key in order to generate a new private key that matches the new public key. In another example, the server generates an update token (alteration code) and applies it to the master public key to generate a new public key. The server sends the update token to the RFID tag encrypted with the previous public key. The RFID tag decrypts this update token using its previous private key. The RFID tag combines this update token with their private secret—a secret scalar or master seed or private key—in order to generate a new private key corresponding to the new public key.

The scanner 102 or 104 may display the authentication information received from server 114. The scanner 102 or 104 may also receive data related to the RFID tag 106 from the server 114 or the blockchain at some point throughout this process. In some implementations, messages sent by the server will be signed using the digital signature associated with the server. In some implementations, messages and authentication information sent to the scanner by the server will be encrypted using a public key related to the scanner. In some implementations, messages sent to the server may be encrypted using a public key related to the server. In some implementations, messages sent from the scanner to the server will be signed using the scanner's digital signature, in which case this signature may be used for the sake of nonrepudiation or to otherwise increase accountability. In some implementations, some or all messages may be encrypted and feature digital signatures to verify message integrity and origin. In some implementations, passwords or go codes may be used in order to initiate decryption and processing of messages.

In some implementations, the server 114 and RFID tag 106 may use asymmetric cryptography, commonly called private-public key cryptography. In some implementations, the “public” key may also be held secret, making both keys private but not symmetrical (aka, the “public” key is a pseudo-public key that is known only to the server 114). In some implementations, the private key would be stored by the RFID tag 106, and the secret public key would be stored on the server 114 or in an associated secure key or data storage location. In some implementations, this key pair would change, and a new private key would be distributed to the RFID tag 106 from the server 114 using the existing key pair.

In some instances, each time a product is verified, the information stored on the RFID tag 106 (the key, a digital signature, or authentication data associated with the RFID tag 106, etc.) is changed in order to prevent duplication of the RFID tag 106 and its data.

In some instances, re-keying, or a method of altering or reassigning asymmetric keys, may be used. In some instances, the key distribution method for distributing these new keys or key alterations may use the existing asymmetric key pair. In some instances, a method of altering or reassigning asymmetric keys (sometimes referred to as key rotation or re-keying) may be used for authentication and may use a method of key distribution via existing asymmetric keys. In some instances, this method may be applied in applications outside of physical product counterfeiting, such as transmitting keys, establishing connection between devices or entities, secure transfer of data, and authentication.

The system may use asymmetric cryptography with changing key pairs. This asymmetric cryptography will create a pair of non-identical but corresponding keys, often called a private key and a public key. In some implementations, the “public” key, may be kept secret and private, effectively forming a private-private key asymmetric encryption. This secret public key may also be used to enable bi-directional asymmetric encryption. In some instances, session keys may be used for further security.

For using asymmetric cryptography, also referred to as public key encryption or public-private key pairs: A method of changing the private key (for example, the private key stored on the tag 106) repeatedly, (such as after each successful verification) in order to increase security.

For example, the present disclosure describes a method of securely distributing asymmetric keys by sending a new private key using the old private key. In one example, the server 114 and RFID tag 106 may have an existing asymmetric key pair where the private key is stored securely on the RFID tag 106 and the public key is stored securely on the server 114. When prompted, such as after a successful authentication attempt, the server may generate a new asymmetric key pair for the RFID tag 106 and encrypt the new private key for the RFID tag 106 with the old public key for the RFID tag 106 and send this encrypted new private key for the RFID tag 106 to the RFID tag 106 (via the scanner 102 or 104). The RFID tag can then decrypt the new private key for the RFID tag using the old private key for the RFID tag and store the new private key. The RFID tag 106 may then send back a confirmation message to the server 114 (via the scanner 102 or 104), prompting it to stop storing the original key pair or the key it sent to the tag. The RFID tag 106 uses the new private key in a subsequent authentication process.

In another variation of a method for using asymmetric cryptography, also referred to as public key encryption or public-private key pairs, with confidential public keys, the RFID tag 106 may have a private key and the server 114 may have a corresponding key typically referred to as a “public key” associated with the RFID tag 106. In this example, unlike traditional applications, the public key associated with the RFID tag 106 is not made public. Rather the public key is not shared publicly but held secret by the server 114 or an affiliated server system. In some applications, this would allow for asymmetric key pair to be used bi-directionally similar to how a symmetric key pair is often used where both parties can securely send and encrypt messages, as well as receive and decrypt messages and verify their origin using the same asymmetric key pair.

Continuing with FIG. 1, in some implementations, the RFID reader 102 or 104 communicates a digital ID and encrypted authentication code to the blockchain server 114. In some implementations, the authentication code can be a response to a challenge question issued by the server 114 and provided to the RFID tag 106 by the scanner 102 or 104. For example, the server 114 issues a challenge to the RFID tag 106 by communicating the challenge over the network 110 to the scanner 104. In some cases, the challenge can be encrypted using a key for the RFID tag 106, such as a public key for the RFID tag (including use of a secret public key for the RFID tag 106). The scanner 104 communicates the challenge to the RFID tag 106. The RFID tag 106 generates a response to the challenge. In some cases, generating the response to the challenge can include the RFID tag decrypting the challenge code that is encrypted with the public key of the RFID tag to get the unencrypted challenge code in plaintext, and then re-encrypting this plaintext challenge code using the private key for the RFID tag, a public key for the server, or another code. In some cases, generating the response to the challenge can include decrypting the challenge using a private key for the RFID tag 106, executing a predetermined function or hash on the authentication code, and then encrypting the response. In some cases, generating the response to the challenge can include decrypting the challenge using a private key for the RFID tag 106, generating the response to the challenge, and then encrypting the response using the private key for the RFID tag 106. The RFID tag 106 then sends the response to the scanner 104 which communicates the response to the server 114 over the network 110.

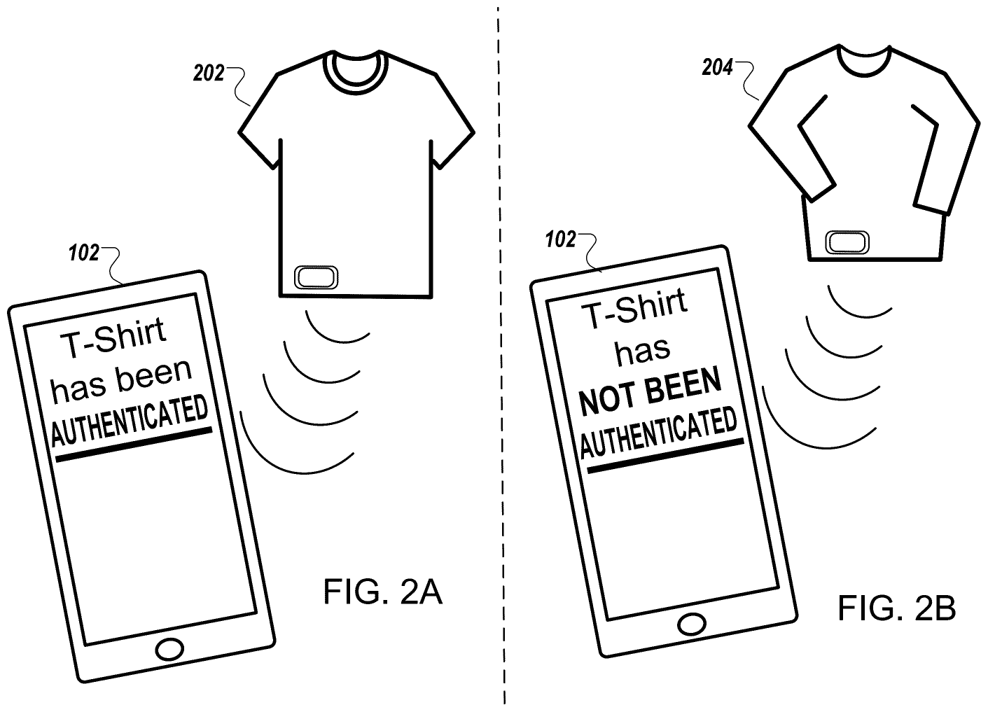

The one or more processing devices at the blockchain server 114 can compare the received digital ID and encrypted authentication code to the data stored in the immutable ledger at the blockchain server 114 (or to information stored at storage locations identified by links or pointers stored as part of the immutable ledge) to determine whether the data matches. In some cases, determining if the authentication code matches stored data includes determining if a response generated by the RFID tag 106 matches an answer to a challenge issued by the server 114. Based on the blockchain server 114 determining that the received data matches the data stored in its immutable ledger (or is otherwise authentic), the blockchain server 114 then sends one or more communications to the reader 102 or 104 indicating that the product 108 is authentic. The scanner 102 or 104 can then communicate the authentic status of the product 108 to the user. For example, as illustrated in FIG. 2A, the RFID scanner 102 or 104, may display on a display screen of the scanner, that the product to which the RFID tag is attached is authentic or otherwise verified. In some implementations, when the RFID scanner 102 or 104 determines that a product 108 is authentic, the RFID scanner 102 or 104 communicates with a computing system associated with the manufacturer, distributor, or other source of the product 108 to report that an authentication process for the product 108 has occurred. In some implementations the blockchain server 114 records a log to the blockchain indicating that the authentication process for the product 108 has occurred along with relevant data, such as a date and time of the authentication process, a location of the product 108 and/or RFID scanner 102 or 104, an identifier for a user of the RFID scanner 102 or 104, information about potential transfer of ownership, or other relevant information for the authentication process.

In some implementations, the RFID scanner 102 or 104 decrypts the encrypted authentication code received from the RFID tag 106 prior to transmitting the authentication code to the blockchain server 114. For example, the RFID scanner 102 or 104 can receive the digital ID for the RFID tag 106 and/or product 108 and provide the digital ID to the blockchain server 114 which can return the public key for the RFID tag based on the blockchain server 114 using the digital ID to retrieve the public key. The RFID scanner 102 or 104 can, for example, receive the digital ID and the encrypted authentication code as part of the same communication with the RFID tag 106 or, in some cases, may receive the digital ID prior to receiving the encrypted authentication code from the RFID tag 106. Once the RFID scanner 102 or 104 has both the encrypted authentication code for the RFID tag 106 and the public encryption key for the RFID tag 106, the RFID scanner 102 or 104 can decrypt the authentication code using the public key prior to transmitting the authentication code to the blockchain server 114. In some implementations, the RFID scanner 102 or 104 retrieves the public key for the RFID tag 106 from a computing system other than the blockchain server 114. In some implementations, rather than using a public key to decrypt the authentication code, the RFID scanner 102 or 104 may be part of a proprietary system and use a private key to decrypt the authentication code. In other words, a private-private encryption and decryption scheme is used in which a private key (either the same private key or two different, asymmetric, private keys at the different devices) is used for both encryption and decryption.

In some implementations, the RFID scanner 102 or 104 does not decrypt the authentication code prior to transmitting the authentication code to the blockchain server 114. In some such cases, the blockchain server 114 can use the public key for the RFID tag 106 to decrypt the authentication code and then compare the authentication code to the digital signature stored in the immutable ledger to authenticate the product 108. In some implementations, the RFID scanner 102 or 104 decrypts the authentication code as described above and then encrypts the authentication code using a private encryption key for the RFID scanner 102 or 104. The RFID scanner 102 or 104 can then provide the newly encrypted authentication code along with the digital ID for the RFID tag 106 and a digital ID for the RFID scanner 102 or 104 to the blockchain server 114. The blockchain server 114 can use the digital ID for the RFID scanner 102 or 104 to retrieve a public encryption key for the RFID scanner 102 or 104 that the blockchain server 114 can use to decrypt the authentication code that has been encrypted by the RFID scanner 102 or 104 using the private key for the RFID scanner 102 or 104.

In some implementations, when the blockchain server 114 determines that the received data does not match the data stored in its immutable ledger, the blockchain server 114 may communicate a message to the RFID scanner 102 or 104 indicating that the product is not authentic. For example, as illustrated in FIG. 2B, the RFID scanner 102 or 104, may display on a display screen of the scanner, that the product to which the RFID tag is attached is not authentic. In some implementations, when the RFID scanner 102 or 104 determines that a product 108 is not authentic, the RFID scanner 102 or 104 can cause a notification to be sent to a manufacturer, distributor, or other entity associated with authentic versions of the product that the non-authentic product 108 is imitating to inform the manufacturer, distributor, or other entity of the possible counterfeit item. In some implementations, when the RFID scanner 102 or 104 determines that a product 108 is not authentic, the RFID scanner 102 or 104 communicates with a law enforcement server (e.g., such as a server associated with customs or import/export control) to provide the details of the data received from the counterfeit product.

The RFID scanner 102 or 104 can receive the public key for the RFID tag 106 from the server 114 (or another server or server system), and can use the public key to decrypt the authentication code received from the tag 106. In some implementations, the server 114 may use the public key for the RFID tag 106 to decrypt the authentication code. For example, the scanner 102 or 104 does not decrypt the authentication code but rather passes the encrypted information from the RFID tag 106 to the server 114 through the network 110 such that the server 114 performs decryption of the information from the RFID tag 106. In some implementations, the RFID scanner 102 or 104 communicates the authentication code to the blockchain server 114. In some implementations, the RFID scanner 102 or 104 may encrypt the authentication code using a private key from the scanner 102 or 104. The blockchain server 114 can compare the received authentication code to the digital signature stored at the blockchain. In some implementations, the server 114 compares the authentication code to an answer to a challenge issued by the server 114, the answer being stored at the blockchain. In some implementations, the answer is stored at the server 114 rather than the blockchain. Based on the blockchain server 114 determining that the authentication code matches the stored information, the blockchain server 114 can communicate an authentication message to the RFID scanner 102 or 104. For example, as illustrated in FIG. 2A, the RFID scanner 102 or 104 can display an authentication message indicating that a product is authentic. In some implementations, the RFID scanner 102 or 104 can produce an audible message from a speaker of the device. In another implementation, the RFID scanner 102 or 104 can activate one or more visual indicators using one or more colored lights (e.g., green light for authentic product, red light for inauthentic product).

In some implementations, the RFID tag 106 can be configured to update a unique code associated with the tag 106 to attempt to further combat potential counterfeiting and duplication. In these implementations, the RFID tag 106 may include an alteration algorithm that is designed to automatically update the digital ID, authentication code, signature, or encryption key associated with the RFID tag 106 and prompt the RFID tag 106 to communicate the updated digital ID to the blockchain server 114 (via scanner 102 or 104). The RFID tag 106 can then use the updated unique code in a subsequent authentication process. Based on the algorithm updating the digital ID associated with the RFID tag 106, the digital signature and password can be simultaneously updated and stored at the blockchain server 114. Automatically updating the digital ID associated with the RFID tag 106 after authentication of the product 108 ensures that even if a forger was able to create duplicates of the RFID tag 108 and the currently stored code currently, any duplicate RFID tags would become obsolete when a user attempts to authenticate the old digital ID or use the old credentials (such as use of an old authentication code or use of an old private key for the RFID tag 106).

In some implementations, the blockchain server 114 employs the alteration algorithm. In these implementations, the blockchain server 114 can communicate an alteration to the RFID tag 106 each time the blockchain server 114 authenticates the product 108 the tag is attached to. In other implementations, the blockchain server 114 can communicate an alteration to the RFID tag 106 periodically. In these implementations, the blockchain server 114 may be in communication with one or more servers that store counterfeiting rate data associated with the particular product. When the blockchain server 114 receives data from the one or more servers that store counterfeiting rate data indicating that rates of counterfeiting the product 108 are above a particular threshold value, the blockchain server 114 may employ the alteration algorithm to initiate updating the digital ID of the one or more RFID tags 106 associated with one or more products 108. The server may also identify and respond to scanners with abnormal behavior or counterfeit data. When the blockchain server 114 receives data from the one or more servers that store counterfeiting rate data indicating that the rates of counterfeiting the product are below the particular threshold value, the blockchain server 114 may determine not to employ the alteration. In other implementations, the blockchain server 114 can communicate an alteration to the RFID tag 106 randomly.

In some implementations, the RFID tag 106 can include anti-tampering technology to prevent cloning, emulating, reading or altering of any aspects of the tag 106. For example, the RFID tag 106 can include magnets, tampering detection, or a kill switch, which may be configured to wipe the tag 106 of data. In some implementations, the RFID tag 106 can include physically unclonable functions (PUF), a unique subcircuit, or specialized printing or other details.

In some implementations, the RFID tag 106 can act as a blockchain node. In these implementations, the RFID tag 106 can act as an active tag. The active RFID tag can perform hashing or other data encryption techniques. For example, the active RFID tag can produce digital signatures and perform asymmetric encryption by generating and sharing private and public keys for data encryption and decryption.

FIGS. 2A and 2B illustrate examples of authentication notifications displayed on an RFID scanner 102 or 104. As illustrated in FIG. 2A, an RFID scanner 102 or 104 can be used to scan an RFID tag incorporated in, affixed to, or otherwise associated with a product, such as a luxury clothing item 202. As described above, the RFID scanner 102 or 104 can be a handheld RFID scanner, a large RFID scanning gate, an RFID sweeper, a general purpose computing device (such as a mobile computing device) executing a scanning application, or any other suitable RFID reader. In some implementations, the RFID scanner 104 may be a proprietary scanning device that is controlled by a manufacturer of a product 108. When a user scans the clothing item 202 and confirms that the clothing item 202 is authentic, the display screen on the RFID scanner 102 or 104 can display an authentication message indicating as such. For example, the RFID scanner 102 can communicate with the blockchain server 114 which compares a digital identifier and authentication code for the clothing item 202 to corresponding information stored on the blockchain to authenticate the clothing item 202. The blockchain 114 then sends an authentication message to the device 102 which causes the device 102 to provide an authentication indication to the user. In some examples, the RFID scanner 102 or 104 can output an audible message, alert, or tone indicating that the clothing item 202 is authentic.

In some implementations, the scanning device is a long range scanning device, such as in some of the examples given above. A long range scanning device can allow for thwarting of intentional counterfeiters as such long range scanning devices do not require the person who is in possession of the product 108 to voluntarily or knowingly submit to authentication. Thus, manufacturers, distributors, brands or law enforcement (such as customs or import/expert control) can scan RFID tags of products to authenticate such products. In some implementations, such users could use image recognition (such as Ai or computer vision) to identify potentially counterfeit products and then conduct long range scanning to determine the authenticity of such potentially counterfeit products. Utilizing larger RFID tags with larger ranges can also help with such use cases. Allowing for scanning of RFID tags at medium to long range can better meet the needs of the users by allowing the identification of intentional counterfeiting. By providing long range scanning capabilities, the entities can evaluate the authenticity of products without requiring users to submit their products for authentication, addressing the previously unsolved problem of knowledgeable counterfeiting.

As illustrated in FIG. 2B, when the user scans the clothing item 204 and determines that the clothing item 204 is not authentic (e.g., by receiving one or more communications from the blockchain server 114 indicating that the clothing item 204 is not authentic based on a failure to verify an authentication code provided by an RFID tag of the clothing item 204), the display screen on the RFID scanner 102 or 104 can display a message indicating that the clothing item 204 is not authentic. In some examples, the RFID scanner 102 or 104 can output one or more visual indicators including one or more colored lights. For example, when a product is determined not be authentic, the RFID scanner 102 or 104 may output a red flashing light.

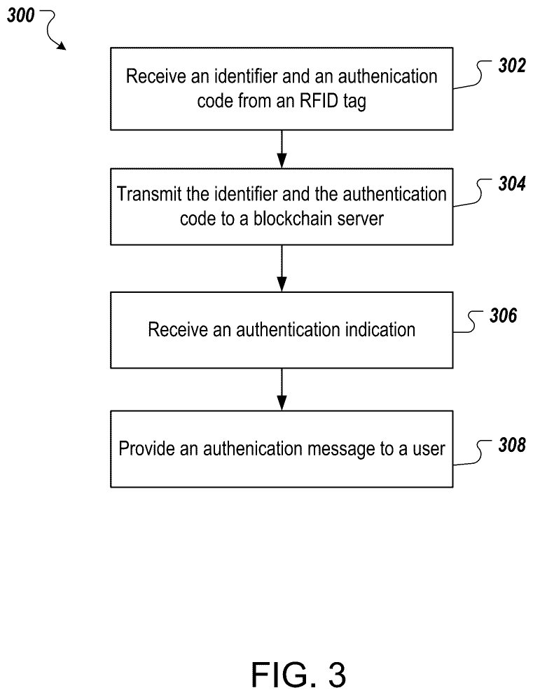

FIG. 3 illustrates exemplary process 300 for providing an authentication message to a user. The following describes process 300 as being performed by components of the system 100 described above with respect to FIG. 1. However, the process 300 may be performed by other systems and configurations. Briefly, the process 300 may include receiving, by a computing device, an identifier and an authentication code from an RFID tag, wherein the RFID tag is associated with a physical object (302), transmitting, by the computing device, the identifier and the authentication code to a blockchain server (304), receiving, by the computing device from the blockchain server, an authentication indication, the authentication indication having been provided by the blockchain server responsive to the blockchain server comparing the identifier to a digital ID stored on a blockchain and comparing the authentication code to a digital signature associated with the digital ID at the blockchain to determine that the authentication code matches the digital signature (306), and providing, by the computing device and responsive to receiving the authentication indication, an authentication message to a user of the computing device, the authentication message including an indication that the physical object is authentic (308). These steps, such as steps 302 and 304, may be conducted in multiple stages. For example, the computing device may first receive the identifier for the RFID tag, provide the identifier to a server, receive a challenge issued by the server, provide the challenge to the RFID tag, then receive the authentication code from the RFID tag, where the authentication code is a response to the challenge issued by the server. The computing device then provides the authentication code to the server such that the server uses the authentication code (the response to the challenge) to verify the RFID tag. The server then provides an authentication message to the computing device upon authentication of the authentication code.

In more detail, process 300 may include receiving, by a computing device, an identifier and an authentication code from an RFID tag, wherein the RFID tag is associated with a physical object (302). For example, this may correspond to the one or more processing devices at a computing device receiving a digital identifier for a specific product and an authentication code from an RFID tag 106 that is attached to the product 108. In some implementations, the identifier and authentication code are received by the computing device at different times. For example, the computing device may receive the identifier before receiving the authentication code. In some implementations, the authentication code is received by the computing device in response to a query issued by the computing device to the RFID tag. In some implementations, the authentication code is a response to a challenge issued by the server (the challenge being received by the computing device from the server and then provided to the RFID tag by the computing device).

The computing device may be a device that is managed by a manufacturer or seller of the product. For example, the computing device may be a portable computing device of an employee of the manufacturer. In some implementations, the computing device may be a proprietary scanning device specific to a manufacturer. For example, the computing device may be a handheld RFID scanner designed to authenticate products produced by the specific manufacturer. The manufacturer or brand may choose to control or limit access to this canner in order to gain control over product authentication or resale services, either through licensing or controlling the market themselves. In other implementations, the computing device may be a computer that is used by the manufacturer to store data associated with the one or more products produced by the manufacturer. In other implementations, the computing device may be integrated with another computer system that provides additional functionality such as an inventory monitoring and management, logistics, supply chain management, customer relations management, or sales system, which the manufacturer or their employees may already be using.

As described above, an RFID tag 106 may be associated with a physical object. For example, the RFID tag 106 may be affixed to a product 108. The RFID tag 106 can be integrated into an adhesive label or a sticker that may be attached to a product 108 or packaging of a product 108. In some examples, the RFID tag 106 can be an RFID inlay that includes an RFID chip and an antenna. In these examples, the RFID inlay may be embedded into the packaging of the product. In some implementations, the RFID tag 106 can be small and light weight, for example, an RFID tag used on a jewelry product. In other implementations, the RFID tag 106 can be flexible and/or stretchable in one or more directions. The identifier can be unique to the product to which the RFID tag 106 is attached. When a user uses an RFID scanner 102 or 104 to scan the RFID tag 106 on the product 108, the RFID scanner 102 or 104 may detect the identifier specific to the RFID tag 106. The digital identity of the product may also contain notes about the physical product such as its color, etc., in order to allow users to easily recognize discrepancies and ensure it matches the physical product. In some implementations, the RFID chip may use a card with microprocessor and memory functionality, such as a smart card.

The process 300 may include transmitting, by the computing device, the identifier and the authentication code to a blockchain server (304). For example, this may correspond to the one or more processing devices of the computing device communicating the identifier and authentication code to a blockchain server 114. As described above, the blockchain server 114 may be a server or a node within a blockchain network which hosts a copy of the immutable blockchain ledger. In some implementations, the computing device transmits the identifier and the authentication code to the blockchain server at different times. For example, the computing device transmits the identifier to the server before transmitting the authentication code to the server. In some implementations, the computing device transmits the identifier to the server, receives a communication from the server in response to transmitting the identifier to the server, provides the received communication from the server to the RFID tag, and then receives the authentication code from the RFID tag in response to providing the received communication from the server to the RFID tag. For example, the communication from the server can be a challenge. In some implementations, the challenge is encrypted using a key associated with the RFID tag. The authentication code received from the RFID tag can be a response to the challenge generated by the RFID tag. In some implementations, the RFID tag encrypts the authentication code (the response to the challenge) using a private key for the RFID tag.

The process 300 may include receiving, by the computing device from the server, an authentication indication, the authentication indication having been provided by the server responsive to the server comparing the identifier to a digital ID stored on a blockchain and comparing the authentication code to a digital signature associated with the digital ID at the blockchain to determine that the authentication code matches the digital signature (306). For example, this may correspond to the blockchain server 114 indicating whether the identifier matches the digital ID stored on the blockchain. The digital ID stored on the blockchain 114 may be a unique digital token which is created to represent a specific product on the blockchain. The digital ID can identify a digital representation of an individual product, and in combination with a digital signature for the product can act as a digital certificate of authenticity of the product. The digital ID can be stored along with data and attributes associated with the product or otherwise used to identify or access data and attributes associated with the product. For example, the digital ID may be used to identify or access records of ownership and transaction history associated with the product. The records can also include information about materials, components, metadata, and transaction records such as to verify use of fairtrade animal or food products. The records may include information such as color, size, model, or other physical characteristics used to authenticate the product, etc., that would help an employee to further physically verify the authenticity of the product by confirming it matches the description. These characteristics may be obvious things such as the color, details such as the rate at which a component on a watch rotates, or secret or nuanced characteristics included in the product by the manufacturer to aid in physical authentication. The records may also include information about the ownership or sales status of a product, such as whether it is in transit, in a store, sold to a customer, etc., for purposes of inventory and supply chain management, data collection, as well as to prevent the sale of products stolen or lost at some point in the supply chain, or to allow users to mark a product as stolen and prevent the resale of stolen products. In some instances, the records associated with a product may be stored on the blockchain as an immutable log. In some examples, variables such as the status of a product may be kept for further security. In some examples, the status of the product will indicate its place in the product life cycle-whether it had been sold, stolen, still in production, in transit, etc. In some such examples, this status may be used to prevent the resale of stolen products or tags. In some examples, this may be used to track how many times the product has been resold, for example with handbags or the deeds to automobiles. In some examples, this may also include information about any maintenance or repairs that the product received, or any damage it was subjected to. In some examples, the product will be associated with a digital certificate of authenticity and an NFT with a secure minting process to prevent the creation of fakes. In some examples, the company or manufacturer, or the provider of this technology, may have control over this minting process. In some examples, the blockchain will manage an immutable audit log of product authentication attempts, sales, and the creation of new products. In some examples, this log will be built to help identify and protect against cyberattacks and address the damage done by them. In some examples, the entity responsible for the logged events may be recorded as well, for example, by recording the digital signature of the scanning device used in an authentication attempt or the identity of the entity trying to create new product certificates. In some examples, a unique identification number, product certification, NFT, or digital twin may be used as the digitized representation of the physical item. The records may include information about regulatory compliance, such as to allow regulators, consumers, partnering brands or the company itself to verify, track, manage, confirm, and record data about regulatory compliance.

The blockchain server 114 may associate the digital ID with a digital signature of the RFID tag. The digital ID and the digital signature of the RFID tag may be stored in the immutable ledger of the blockchain. During an authentication verification process, the blockchain server 114 compares the stored digital signature of the RFID tag 106 to the authentication code received from scanning the RFID tag 106 on a product 108. In some implementations, the authentication code is a response to a challenge issued by the server, the response is generated, for example, by the RFID tag 106. The digital signature can be an answer to the challenge that is generated by the server. The process 300 may include providing, by the computing device and responsive to receiving the authentication indication, an authentication message to a user of the computing device, the authentication message including an indication that the physical object is authentic (308). For example, this may correspond to the blockchain server 114 authenticating a product 108 tagged with the RFID tag 106. The blockchain server 114 can authenticate the product tagged with the RFID tag 106 when the identifier matches the digital ID stored on a blockchain and the authentication code matches the digital signature associated with the digital ID at the blockchain.

In some implementations, the authentication code received from the RFID tag 106 at the computing device may be encrypted. In these implementations, the one or more processing devices at the computing device can transmit the identifier to the blockchain prior to transmitting the authentication code to the blockchain server 114. When the blockchain server 114 determines that the identifier for the RFID tag 106 matches the digital ID which may be stored in the server or on the blockchain, the blockchain server 114 can provide the public key associated with the RFID tag 106 to the computing device. The one or more processors at the computing device can decrypt the encrypted authentication code using the public key associated with the RFID tag 106. In other instances, the decryption of the authentication code may be done on the server itself, and the computing device (scanner) would forward all of the information to the server without decrypting it first. In some instances, the computing device (scanner) may also sign its communications for authenticity and accountability, and verify the signatures of communications coming from the server. When the one or more processors at the computing device decrypt the encrypted authentication code, the one or more processors then transmit the authentication code to the blockchain server 114. In some implementations, the RFID tag 106 can use a different encryption method to encrypt the authentication code. For example, the RFID tag 106 can use symmetric encryption, where the same key is used to both encrypt and decrypt the authentication code. In another example, a hash function can be used to encrypt the authentication code. In some implementations, hybrid encryption can be used to encrypt the authentication code. In these implementations, a combination of symmetric and asymmetric encryption methods may be used to encrypt and decrypt the authentication code.

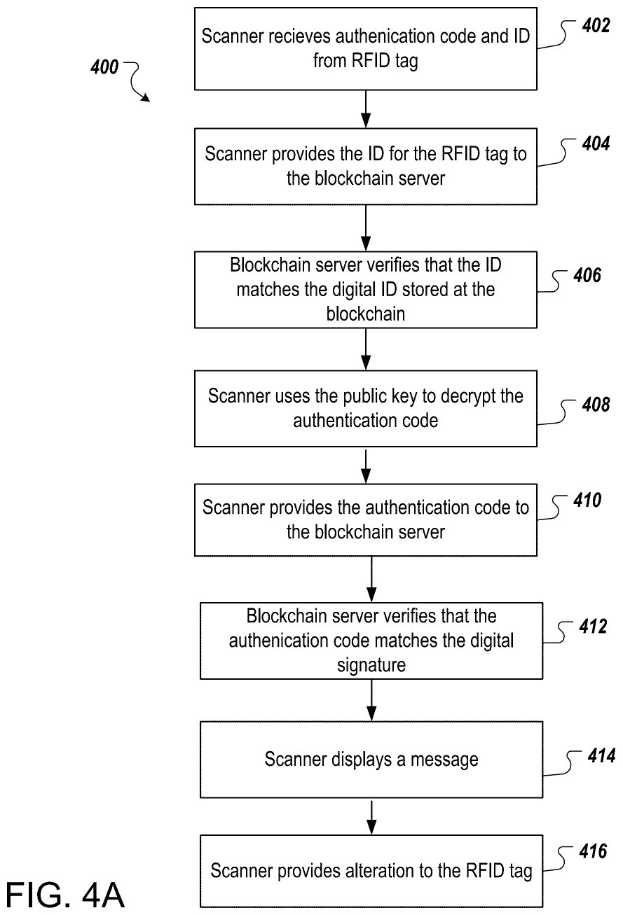

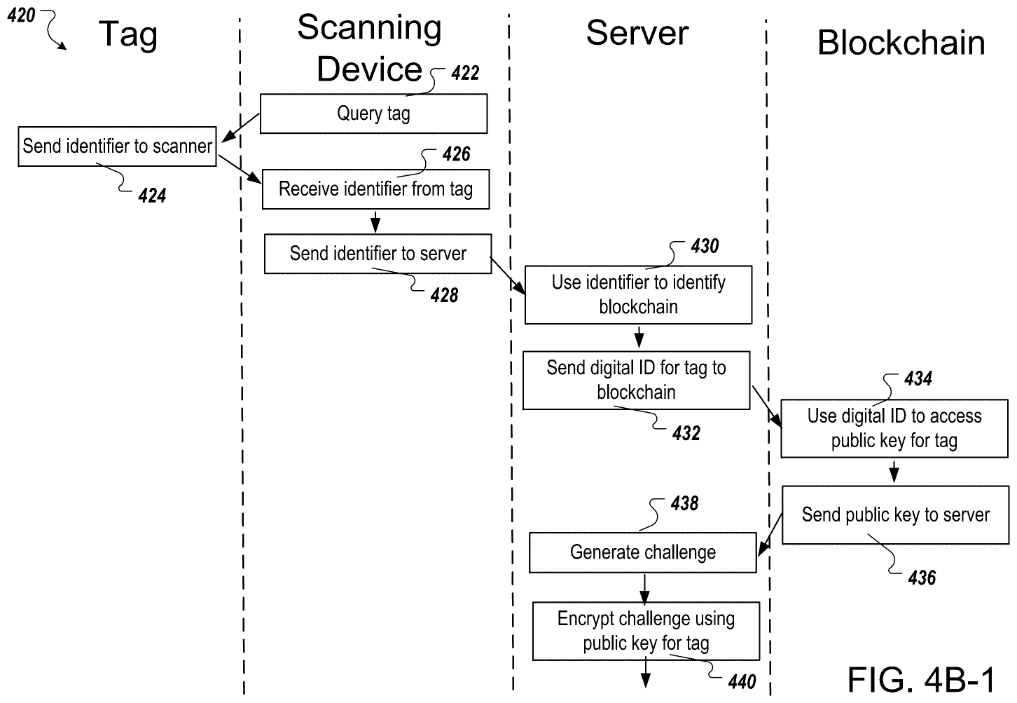

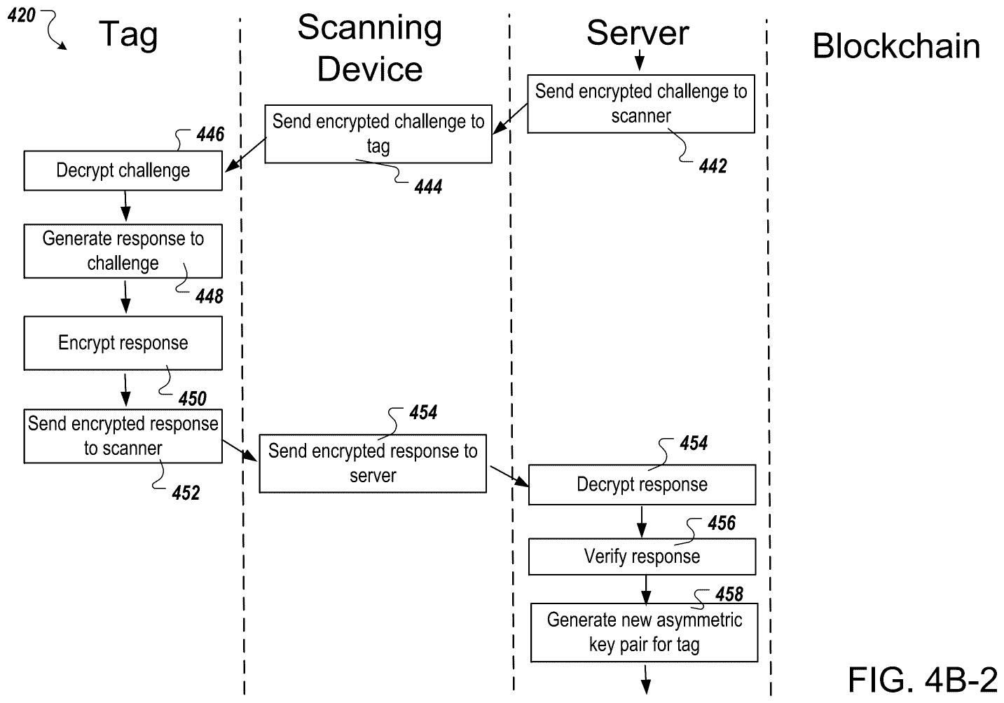

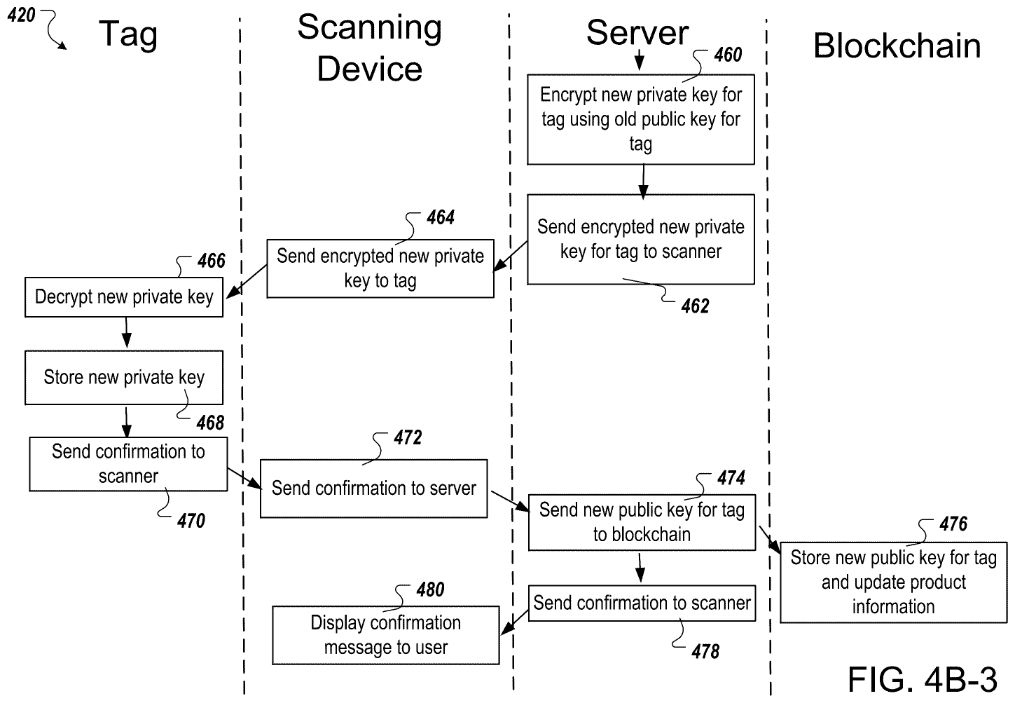

FIG. 4A illustrates exemplary process 400 for providing an alteration to the RFID tag. The following describes process 400 as being performed by components of the system 100 described above with respect to FIG. 1. However, the process 400 may be performed by other systems and configurations. Briefly, the process 400 may include a scanner receiving an encrypted authentication code and ID from an RFID tag (402), the scanner providing the ID for the RFID tag to a blockchain server (404), the blockchain server verifying that the ID matches the digital ID stored at the blockchain and providing a public key for the RFID tag to the scanner (406), the scanner uses the public key for the RFID tag to decrypt the authentication code (408), the scanner provides the authentication code to the blockchain server (410), the blockchain server verifies that the authentication code matches the digital signature stored at the blockchain and providing an authentication message and alteration to the scanner (412), the scanner displays a message or otherwise notifying the user that the item associated with the RFID tag is authentic (414), and the scanner provides the alteration to the RFID tag (416).

In more detail, process 400 may include a scanner receiving an encrypted authentication code and ID from an RFID tag (402). For example, this may correspond to an RFID scanner 102 or 104 scanning an RFID tag 106 that is attached to a product 108 to determine whether the product 108 is authentic. The RFID scanner 102 or 104 can be a handheld RFID scanner, or an electronic device, such as a cellular phone which is configured to read RFID tags. When the RFID scanner 102 or 104 communicates with the RFID tag 106, the RFID scanner can request specific data from the RFID tag 106. In response, the RFID tag 106 may communicate the requested data and a digital signature specific to the RFID tag 106. The digital signature may be generated using a private key when asymmetric encryption is being used. In some implementations, the authentication code and ID are received from the RFID tag 106 as part of the same communication. In some implementations, the authentication code and ID are received as two different communications at different times.

The process 400 may include the scanner providing the ID for the RFID tag to a blockchain server (404). For example, this may correspond to the one or more processing devices of the RFID scanner communicating the data received from the RFID tag to the one or more servers at the blockchain. The process 400 may include the blockchain server 114 verifying that the ID matches the digital ID stored at the blockchain and providing a public key for the RFID tag to the scanner (406). The blockchain server 114 may compare the received ID to the digital ID stored at the immutable ledger at the server. Based on blockchain server 114 determining that the received ID matches the stored digital ID, the blockchain server 114 communicates the public key for the RFID tag 106 to the scanner 102 or 104.

The process 400 may include the scanner using the public key for the RFID tag to decrypt the authentication code (408). For example, this may correspond to the scanner 102 or 104 decrypting the authentication code received from the RFID tag 106 using the public key received from the blockchain server 114. The process 400 may include the scanner providing the authentication code to the blockchain server (410). When the scanner 102 or 104 decrypts the authentication code using the public key, the scanner 102 or 104 then communicates the decrypted code to the blockchain server 114. In some implementations, the scanner 102 or 104 can encrypt the authentication code with a private key specific to the scanner 102 or 104 before communicating the code to the blockchain server 114.

The process 400 may include the blockchain server verifying that the authentication code matches the digital signature stored at the blockchain and providing an authentication message and alteration to the scanner (412). The blockchain server 114 compares the authentication code received from the scanner 102 or 104 to the digital signature specific to the product and stored at the immutable ledger of the blockchain. When the blockchain server 114 determines that the authentication code received from the scanner 102 or 104 matches the stored digital signature, the blockchain server 114 provides an authentication message to the scanner, identifying that the product is authentic.

In some implementations, the blockchain server 114 provides an alteration to the scanner 102 or 104. In these implementations, the RFID tag 106 on the product 108 may have the ability to repeatedly change the digital identifier associated with the tag 106, the authentication code associated with the tag 106, an authentication function or value associated with the tag 106, a key (such as a private key) associated with the tag 106, or any combination of these values. In more detail, the RFID tag 106 may be equipped with a unique algorithm that is stored at the device, the algorithm may be configured to change the digital signature associated with the RFID tag 106 when the tag is scanned by an RFID scanner 102 or 104 and verified. As described above, when an RFID tag 106 on an authentic item is scanned, the RFID tag 106 communicates an identifier to the blockchain server 114, and the blockchain 114 compares the identifier received from the scanned tag to the digital signature stored in the immutable ledger on the blockchain 114. When the blockchain server 114 verifies the match and authenticates the tagged product 108, either through using an encryption technique for the exchange of data or not, the blockchain server 114 can then communicate an alteration to be made to the RFID's tag digital signature for a future authentication check. At the same time, the blockchain server 114 can create a new entry in the immutable ledger to update the digital signature based on the alteration to be made for the tag 106.

In some implementations, after the blockchain server 114 communicates the alteration to the RFID tag 106, the algorithm at the tag 106 updates the digital signature of the tag 106, and communicates the updated digital signature to the blockchain server 114. In some implementations, after the blockchain server 114 communicates the alteration to the RFID tag 106, the RFID tag 106 uses the alteration to alter the authentication code to generate a new authentication code. In various implementations, the alteration received at the RFID tag 106 is used to generate a new ID for the RFID tag 106, a new authentication code for the RFID tag 106, a new private key for the RFID tag 106, or any combination of these values. In some implementations, the unique algorithm can be stored at the RFID reader/scanner device 102 or 104, or can even be stored at the immutable ledger at the blockchain 114. In implementations where the algorithm is stored at the blockchain, the blockchain server 114 communicate the new digital signature to the RFID tag 106 and store the new digital signature at the immutable ledger. In some implementations, the scanner operates to generate a new authentication code based on the alteration and provides the new authentication code to the RFID tag 106. In some implementations, the alteration is a new private key for the RFID tag 106. In such implementations, the RFID tag 106 does not generate the new private key but rather stores the new private key provided by the server. In some implementations, the alteration is a new digital signature, identifier, and/or authentication code for the RFID tag. In such implementations, the RFID tag 106 does not generate a new digital signature, identifier, and/or authentication code but rather stores a new digital signature, identifier, and/or authentication code, as indicated by the alteration information received from the server (via a computing device such as scanner 102 or 104). In some implementations, the alteration is a value, function, or token used to generate a new private key for the RFID tag 106. In such implementations, the RFID tag 106 generates the new private key based on the existing private key associated with the RFID tag 106, a secret seed value, a master private key associated with the RFID tag 106, or other information stored on the tag. In some implementations, the alteration is a value, function, or token used to change the existing private key associated with the RFID tag into a new private key associated with the RFID tag. In such implementations, the RFID tag 106 applies the alteration to their existing private key in order to generate a new private key associated with the RFID tag 106. In some implementations, the server uses the same alteration function, value or token combined with the existing public key associated with the RFID tag 106, a master public key, or other predetermined function, in order to generate a new public key associated with the RFID tag 106.

This process of updating the digital signature associated with the RFID tag 106 on a product prior to a subsequent authentication of said product helps to strengthen the security offered by the use of the RFID tag 106. Because the digital signature (or authentication code, private key, or other information specific to the RFID tag) is updated after each authentication, a counterfeiter who is successful at forging or creating duplicates of a tag and the digital signature associated with the tag at the time of forging, would not be able to use the duplicate tags. For example, the forger may attempt to affix the duplicate tags on counterfeit products, however, when the duplicate tag on the counterfeit product is scanned, the tag would communicate the old digital signature (or old authentication code, or use an old private key to encrypt information) and the product would not be authenticated.

The process 400 may include the scanner displaying a message or otherwise notifying the user that the item associated with the RFID tag is authentic (based on the receive authentication message) (414). For example, this may correspond to blockchain server 114 communicating to the scanner 102 or 104 that the data received from the RFID tag 106 matches the data stored at the blockchain 114. When the blockchain server 114 confirms the match with the data, an authentication message is communicated to the scanner 102 or 104. The scanner 102 or 104 can in turn display an authentication message on a display screen of the device. In some implementations, the scanner 102 or 104 can provide an audible message indicating that the product is authentic. In some implementations, the scanner 102 or 104 can provide an alert or a tone to initiate that the product was authenticated. In other implementations, the scanner 102 or 104 can provide one or more visual indicators to notify a user that the product is authenticated. In yet another implementation, the scanner 102 or 104 can produce a combination of audio and visual alerts to indicate that the product is authentic.

FIGS. 4B-1 to 4B-3 depict a swim lane diagram of an example process for authenticating and providing an alteration to an RFID tag. FIGS. 4B-1 to 4B-3 depict a process 420. Turning first to FIG. 4B-1, the process 420 starts with a scanning device, such as scanning device 102 or 104 of FIG. 1 querying a tag, such as an RFID tag that is affixed to, integrated with, or associated with a product or product packaging (422). The tag sends an identifier for the tag to the scanning device (424). The identifier can be a tag name or other unique identifier. In some implementations, the tag encrypts the identifier using a private key for the tag. The scanning device receives the identifier from the tag (426). The scanning device sends the identifier to a server system (428). In some implementations, the scanning device signs the identifier with its digital signature before sending it to a server system which then verifies the digital signature of the scanning device. The server system uses the identifier to determine a corresponding digital ID and digital representation of the product associated with the tag, including the corresponding blockchain records associated with the product (430). The blockchain, for example, contains the information-such as the storage location or access credentials-required to access the public key corresponding to the tag. The server system sends the determined digital ID to the identified blockchain (432). The blockchain receives the identifier from the server system and uses the identifier to access a public key for the tag or to access information on a location for the public key for the tag (e.g., a link to the public key for the tag) (434). The blockchain sends the public key for the tag or links to a storage location for the public key for the tag to the server system (436). The server system generates an authentication challenge for the tag (438). In some implementations, the server generates the question and sends the question to a key manager, the key manager then encrypts the question using the corresponding public key for the tag and sends it back to the server, such that the public key never leaves the key management service. In some implementations, the key manager sends the key directly to the server. In some implementations, the server system generates an answer to the authentication challenge at the time of generating the authentication challenge and stores the answer to the authentication challenge. The server system encrypts the authentication challenge using the public key for the tag (440).

Turning to FIG. 4B-2, the process 420 continues with the server system sending the encrypted authentication challenge to the scanning device (442). In some implementations, the server will sign this encrypted challenge with its digital signature, the signature subsequently being verified by the tag, the scanning device, or both. The scanning device sends the encrypted challenge to the tag (444). The tag receives the encrypted challenge and decrypts the encrypted challenge using a private key stored at the tag (446). The tag generates a response to the challenge (448). In some implementations, the response to the challenge is simply the decrypted form of the challenge. In some implementations, the tag generates the response to the challenge by performing one or more arithmetic functions on the challenge. In some implementations, the tag generates the response to the challenge by performing a hash function on the challenge. The tag encrypts the response to the challenge (450). This encryption could be performed, for example, using the private key for the tag, using a public key for the server system, using a session key shared by the server at the time the challenge was sent, using a public key for the scanning device, or using another key (e.g., an old private key for the tag). The tag sends the encrypted response to the challenge to the scanning device (452). The scanning device sends the encrypted response to the server system (454). The server system receives the encrypted response and decrypts the response (454). In various implementations, the server system can, for example, decrypt the response using a public key for the tag, using a private key for the server, using a session key, using a public key for the scanning device, or using another key. The server system verifies the response (456). Such verification can include comparing the decrypted response to a previously generated and stored answer to the challenge. In some implementations, such verification can include comparing the decrypted response to the previously generated challenge. In some implementations, such verification can include applying one or more functions to the response. If the received response is incorrect, the server can send a communication to the scanning device indicating that the tag or a product associated with the tag has not been authenticated or is otherwise inauthentic. If the received response is correct, the server can generate an authentication message for transmission to the scanning device. In some implementations, this transmission will be encrypted, for example using a public key for the scanner, and signed using the server's digital signature before being sent to the scanner, which subsequently decrypts, for example with its private key, and verifies the signature. The server system can log both valid and invalid authentication attempts for the tag and for numerous other tags associated with other products. This can include logging an identifier associated with the tag, an identifier associated with the scanning device, the status of the product, the product owner, a date and time of the attempted authentication, and the result (successful/unsuccessful) of the authentication attempt.

If the authentication attempt is successful (i.e., the challenge response is verified), the server system generates a new asymmetric key pair for the tag (458). Turning to FIG. 4B-3, the process 420 continues with the server system encrypting the new private key for the tag using the old public key for the tag (460). The server system sends the encrypted new private key for the tag to the scanning device (462). The server can also send a verification report to the scanning device, signed with the server's digital signature and encrypted, for example, using the scanner's public key. In some implementations, the scanning device decrypts, for example, using its private key, the verification report received from the server system. In some such implementations, the scanning device does not decrypt the new private key generated and transmitted by the server, the scanning device only decrypts the confirmation code portion of the communication. For example, the encrypted confirmation code and the encrypted new private key for the tag can be sent in two different communications, with the confirmation code being encrypted using the public key for the scanning device and the new private key for the tag being encrypted using the old public key for the tag. In some implementations, a confirmation code will be attached to the verification report, such that it can be used in a later step to confirm the successful verification of the product. If the received verification report indicates an unsuccessful authentication attempt, the scanning device displays a message to a user of the scanning device indicating that authentication was unsuccessful. If the received message indicates that the authentication attempt was successful, the scanning device sends the encrypted new private key to the tag (464).

The tag receives and decrypts the new private key for the tag (466). This decryption can be conducted using the old private key for the tag. The tag stores the new private key (468). In some implementations, rather than the server sending a new private key to the tag, the server sends information that is used by the tag to alter the existing private key or generate a new private key for the tag. For example, the tag can use the information received from the server to perform one or more functions on the old private key for the tag to generate the new private key for the tag. The tag can then use the new private key in a future authentication process. The tag sends a confirmation to the scanning device (470). The confirmation can indicate, for example, that the tag successfully received and stored the new private key. In some implementations, this confirmation is encrypted, such as using the old private key for the tag, or the new private key for the tag. In another example, the confirmation can indicate that the tag successfully generated and stored the new private key. The scanning device receives the confirmation from the tag and sends the confirmation to the server system (472). Upon receiving the confirmation, the server system sends the new public key for the tag to the blockchain to be stored (474). The blockchain stores the new public key for the tag and updates information associated with the product (476). In some implementations, rather than sending the new public key to the blockchain to be stored, the server sends the new public key to a key managing service to be stored, with the key managing service being distinct from the blockchain. In some implementations, the blockchain updates information associated with the product. This can include storing information on the attempted authentication, whether or not the authentication was successful, a time and date for the authentication attempt, updating a total number of authentications for the product, and/or storing information on an entity that conducted the authentication attempt (e.g., an entity associated with the scanning device such as a store, company, or individual). The server system sends a confirmation to the scanning device (478). The confirmation can, for example, indicate a successful authentication attempt. The scanning device receives the confirmation and displays a confirmation message to a user of the scanning device indicating a successful authentication attempt.

In some implementations, the server sends the same confirmation code as in the server's prior message to the scanning device with the verification report, encrypted with the scanner's public key and signed with the server's digital signature. The scanner then verifies this signature and decrypts the message with its private key. If the two confirmation codes match, then the product is authenticated. The process 420 can be repeated multiple times for the same tag and in some cases is repeated using a different scanning device for subsequent authentication processes. In subsequent performances of the process 420, the tag can use the new private key for the tag. The process 420 can also be performed by the same scanning device and same server system with respect to multiple different tags, each tag being associated with a distinct product.

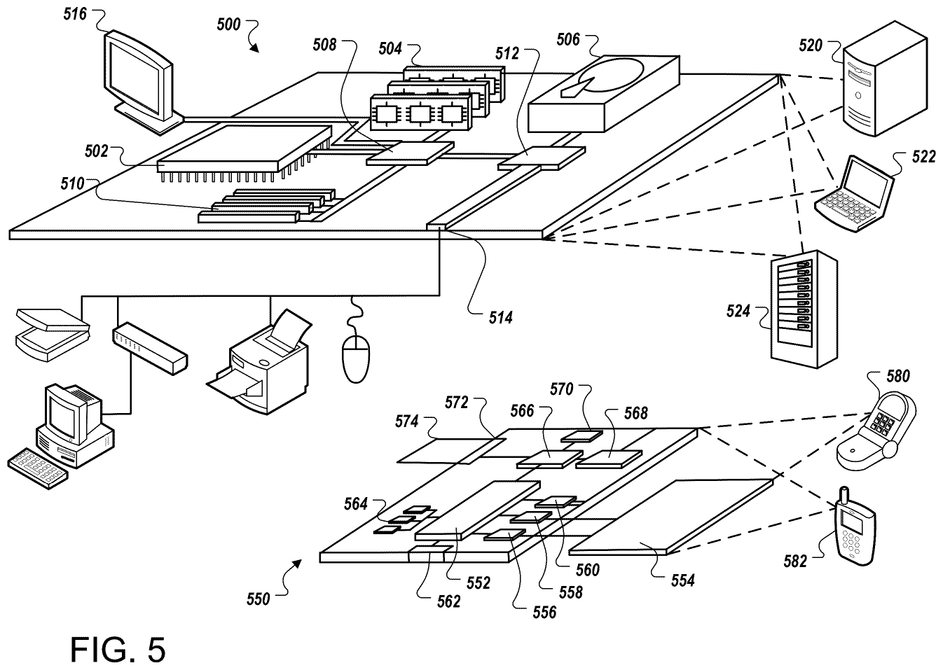

FIG. 5 shows an example of a computing device 500 and an example of a mobile computing device that can be used to implement the techniques described here. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 564, the expansion memory 574, or memory on the processor 552. In some implementations, the computer program product can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, WiFi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A physical item having an integrated RFID tag, the RFID tag configured to:
transmit an authentication code to a scanning device, wherein the authentication code is encrypted using a private key stored at the RFID tag prior to transmitting the authentication code to the scanning device, wherein a server in communication with the scanning device is configured to decrypt the encrypted authentication code using a public key associated with the RFID tag;
receive, from the scanning device, an alteration to be applied to the authentication code, wherein the scanning device is configured to receive the alteration from a blockchain server system in response to the scanning device providing the authentication code to the blockchain server system, wherein the blockchain server system provides the alteration to the scanning device based on the blockchain server system authenticating the authentication code based on information associated with the RFID tag stored in association with a blockchain; and
alter the authentication code using the alteration received from the scanning device to generate a new authentication code.

2. The physical item of claim 1, wherein the scanning device is a first scanning device and the RFID tag is further configured to transmit the new authentication code to a second scanning device, the second scanning device being distinct from the first scanning device.

3. The physical item of claim 1, wherein transmitting of the encrypted authentication code to the scanning device by the RFID tag is performed in response to the RFID tag receiving a query from the scanning device.

4. The physical item of claim 1, wherein the private key stored at the RFID tag is a first private key for the RFID tag and the alteration received by the RFID tag is a new private key for the RFID tag, the new private key replacing the first private key.

5. The physical item of claim 1 wherein the physical item is a bag or garment and the RFID tag is sewn into the bag or garment.

6. The physical item of claim 1 wherein the physical item is a container containing one or more products and the authentication code is associated with the one or more products contained within the container.

7. The physical item of claim 1 wherein:
the authentication code transmitted by the RFID tag to the scanning device is a response to an authentication challenge issued by the blockchain server system; and
authenticating the authentication code by the block chain server includes confirming, by the block chain server, that the authentication code correctly matches an answer to the authentication challenge.

8. The physical item of claim 7 wherein the authentication challenge is encrypted by the blockchain server system using the public key associated with the RFID tag prior to the blockchain server system transmitting the authentication challenge to the scanning device.

9. A computer implemented method comprising:
receiving, by a computing device, an identifier and an authentication code from an RFID tag, wherein the RFID tag is associated with a physical object
transmitting, by the computing device, the identifier and the authentication code to a blockchain server system;
receiving, by the computing device from the blockchain server system, an authentication indication, the authentication indication having been provided by the blockchain server system responsive to the blockchain server system comparing the identifier to a digital ID stored on a blockchain and comparing the authentication code to authentication information associated with the digital ID at the blockchain to determine that the authentication code matches the authentication information; and
providing, by the computing device and responsive to receiving the authentication indication, an authentication message to a user of the computing device, the authentication message including an indication that the physical object is authentic.

10. The method of claim 9, wherein the authentication code is encrypted when received at the computing device from the RFID tag, and wherein the computing device transmits the identifier to the blockchain server system prior to transmitting the authentication code to the blockchain server system, the method further comprising:
after transmitting the identifier to the blockchain server system, receiving, by the computing device, an encrypted challenge from the blockchain server, wherein the blockchain server encrypts the challenge using a public key associated with the RFID tag, wherein the blockchain server system provides the encrypted challenge based on the identifier for the RFID tag matching the digital ID associated with the blockchain; and
transmitting, by the computing device, the encrypted challenge to the RFID tag.

11. The method of claim 9, further comprising:
receiving, by the computing device from the blockchain server system, an alteration, the alteration having been provided by the blockchain server system responsive to the blockchain server system determining that the authentication code matches the authentication information stored on the blockchain; and
transmitting, by the computing device, the alteration to the RFID tag.

12. The method of claim 11, wherein the RFID tag alters the authentication code using the alteration transmitted by the computing device to generate a new authentication code.

13. The method of claim 12 further comprising:
receiving, by the computing device, a new authentication code from the RFID tag;
transmitting, by the computing device, the new authentication code to the blockchain server system;
receiving, by the computing device, a second authentication indication, the second authentication indication having been provided by the blockchain server system responsive to the blockchain server system authenticating the new authentication code based on information stored at the blockchain; and
providing, by the computing device and responsive to receiving the second authentication indication, a second authentication message to the user of the computing device, the second authentication message including an indication that the physical object is authentic.

14. The method of claim 11 wherein the alteration is a new private key for the RFID tag.

15. The method of claim 11 wherein the RFID tag is configured to use the alteration to modify a private key stored at the RFID tag to generate a new private key for the RFID tag.

16. The method of claim 9, wherein the physical object is stored in a container and the RFID tag is physically attached to the container.

17. The method of claim 9, wherein the blockchain server system is associated with an entity that manufactured the physical object.

18. A computing device comprising,
one or more processors;
computer memory containing instructions that, when executed by the one or more processors, cause the system to perform operations comprising:
receiving, by the computing device, an identifier and an authentication code from an RFID tag, wherein the RFID tag is associated with a physical object
transmitting, by the computing device, the identifier and the authentication code to a blockchain server system;
receiving, by the computing device from the blockchain server system, an authentication indication, the authentication indication having been provided by the blockchain server system responsive to the blockchain server system comparing the identifier to a digital ID stored on a blockchain and comparing the authentication code to a authentication information associated with the digital ID at the blockchain to determine that the authentication code matches the authentication information; and
providing, by the computing device and responsive to receiving the authentication indication, an authentication message to a user of the computing device, the authentication message including an indication that the physical object is authentic.

19. The computing device of claim 18, wherein the authentication code is encrypted when received at the computing device from the RFID tag, and wherein the computing device transmits the identifier to the blockchain server system prior to transmitting the authentication code to the blockchain server system, the operations further comprising:
after transmitting the identifier to the blockchain server system, receiving, by the computing device, an encrypted challenge from the blockchain server, wherein the blockchain server encrypts the challenge using a public key associated with the RFID tag, wherein the blockchain server system provides the encrypted challenge based on the identifier for the RFID tag matching the digital ID associated with the blockchain; and
transmitting, by the computing device, the encrypted challenge to the RFID tag.

20. A non-transitory computer-readable medium containing instructions that, when executed by one or more processors, cause the performance of operations comprising:
receiving, by the computing device, an identifier and an authentication code from an RFID tag, wherein the RFID tag is associated with a physical object
transmitting, by the computing device, the identifier and the authentication code to a blockchain server system;
receiving, by the computing device from the blockchain server system, an authentication indication, the authentication indication having been provided by the blockchain server system responsive to the blockchain server system comparing the identifier to a digital ID stored on a blockchain and comparing the authentication code to a authentication information associated with the digital ID at the blockchain to determine that the authentication code matches the authentication information; and
providing, by the computing device and responsive to receiving the authentication indication, an authentication message to a user of the computing device, the authentication message including an indication that the physical object is authentic.
